(19) United States
(12) Patent Application Publication
(10) Pub. No.: US 2004/0254687 A1
(43) Pub. Date: Dec. 16, 2004

(54) Analog signal input boards for protective relays with calibration for board components stored on the board

(76) Inventors: David E. Whitehead, Pullman, WA (US); Carl V. Mattoon, Pullman, WA (US)

Correspondence Address: JENSEN + PUNTIGAM, P.S., SUITE 1020, 2033 6TH AVE, SEATTLE, WA, 98121, US

(21) Appl. No.: 10/449,153

(22) Filed: May 30, 2003

(51) Int. Cl. G05D 17/00

(52) U.S. Cl. 700/292

(57) ABSTRACT

An architectural system for a protective relay used in an electric power system and responsive to analog signals from the electric power line includes a main circuit board which contains a processor for processing digital input signals to carry out specified protection functions. The system further includes an input signal board which includes current transformers (CTs) and potential transformers (PTs) for all three phases and low-pass filters associated therewith. Those components have correction factors associated therewith to correct errors produced by the components. The correction factors are stored on the boards having the components. The signals from the input signal board are applied to the main board for use by the processor, along with the correction factor(s) stored on the input signal board.

### TECHNICAL FIELD

This invention relates generally to the structural architecture of protective relays for power systems, and more specifically concerns the calibration of relay elements which are located on input circuit boards positioned prior to the main processing board which carries out the protection functions.

### BACKGROUND OF THE INVENTION

In the architecture used in current microprocessor-based protective relays for power systems, voltage and/or current input signals from a power line are applied through a conventional connector to the protective relay. This is shown in FIG. 1, specifically a protective relay at 10 with a connector element 12 to which input signals 13 from the power line are applied. From connector 12, the current and/or voltage signals from the power line are applied to what is referred to generally as an interface board 14. On the interface board are current and/or potential (voltage) transformers 16-16 and 18-18, respectively, for each phase of the three-phase power signal, which decrease the level of the input signals to a level which can be applied to the main processor board 20.

On the main board 20 are low-pass filters 22-22 receiving outputs of the CTs and/or PTs, as well as an A/D converter 25, which converts the analog output signals from the low-pass filters 22-22 to digital signals, which in turn are supplied to a main processor 26, which carries out selected protection functions and produces an output at 27 for supervision of the power system.

When relay 10 is constructed by the manufacturer, the complete relay is calibrated by comparing each analog input signal to a predetermined value, with a correction (calibration) factor being determined based on the difference between the input signal and the desired output signals. The total correction factor for the relay is the sum of the errors from the current and potential transformers used in the relay, i.e. the total of the magnitude and phase correction factor per channel, with each channel including a CT or PT and its associated low-pass filter, as well as the small error introduced by the A/D converter for each channel. In previous arrangements, the CTs and PTs are typically located on interface board 14, while the low-pass filters 22-22 (one per channel) are typically located on main board 20.

In summary, there are presently typically two correction factors for each channel, one for signal magnitude, the other for phase. There is a channel for each current (CT) or voltage (PT) transformer (A, B, C phases). There is a low-pass filter (LPF) for each CT and PT. One board often has three CTs (IA, IB and IC) and their associated low-pass filters and three PTs (VA, VB and VC) and their low-pass filters. With a correction factor for each channel, there are a total of six magnitude correction factors and six phase correction factors. In addition, the correction factors compensate for the error (very small) introduced by the A/D converter. The magnitude correction is typically a percentage value, while phase correction is in terms of degrees. All of the calibration factors, i.e. the correction factors for the entire relay, magnitude and phase, are stored on the main board 20 and then carried out/implemented by processor 26.

Such an arrangement is satisfactory as long as none of the input boards for the relay are to be changed, either due to failure of components on the interface board or the low-pass filters on the main board or due to a change in or initial error in system requirements, such as input signal ranges, which require a new input board, or if one or more of the input boards is incorrect for the customer's application, either due to an error by the customer or the manufacturer. Again, a single input board could include all three CTs and PTs and their associated low-pass filters.

In such a case, the entire relay must be returned to the manufacturer for replacement of the appropriate board(s) or components, and then the relay must be recalibrated with the replacement boards/components. This usually takes at least several days to accomplish, resulting in inconvenience to the customer, as well as possibly compromised protection and financial consequences during the time that the relay is not in service.

Although it is known that certain input boards for personal computers are replaceable without recalibration of the entire device, the particular architecture of protective relays, namely, the use of current and/or potential transformers and low-pass filters to carry out protection functions, has resulted in a conventional calibration arrangement involving the entire protective relay in response to replacement of input boards or certain components located prior to the relay processor.

### SUMMARY OF THE INVENTION

Accordingly, the present invention is an architectural structure for a protective relay which is used in an electric power system, wherein the relay is responsive to power signals from an electric power line, comprising: a main circuit board containing a processor for processing digital input signals thereto to carry out protection functions for the relay; and at least one input signal board separate from the main board responsive to analog input signals from the power system, the input signal board having components thereon which require calibration to produce accurate output signals, wherein the input signal board also contains calibration factor(s) necessary for said accurate output signals, wherein non-calibrated output signals from the components on the input signal board are, following analog-to-digital conversion, communicated to said processor, along with the calibration factors stored on the input signal board, for processing, wherein a change of the input signal board does not require recalibration of the entire relay.

### BRIEF DESCRIPTION OF THE DRAWINGS

FIG. 1 is a block diagram showing a prior art arrangement of a protective relay.

FIG. 2 is a block diagram showing the structural arrangement of the present invention.

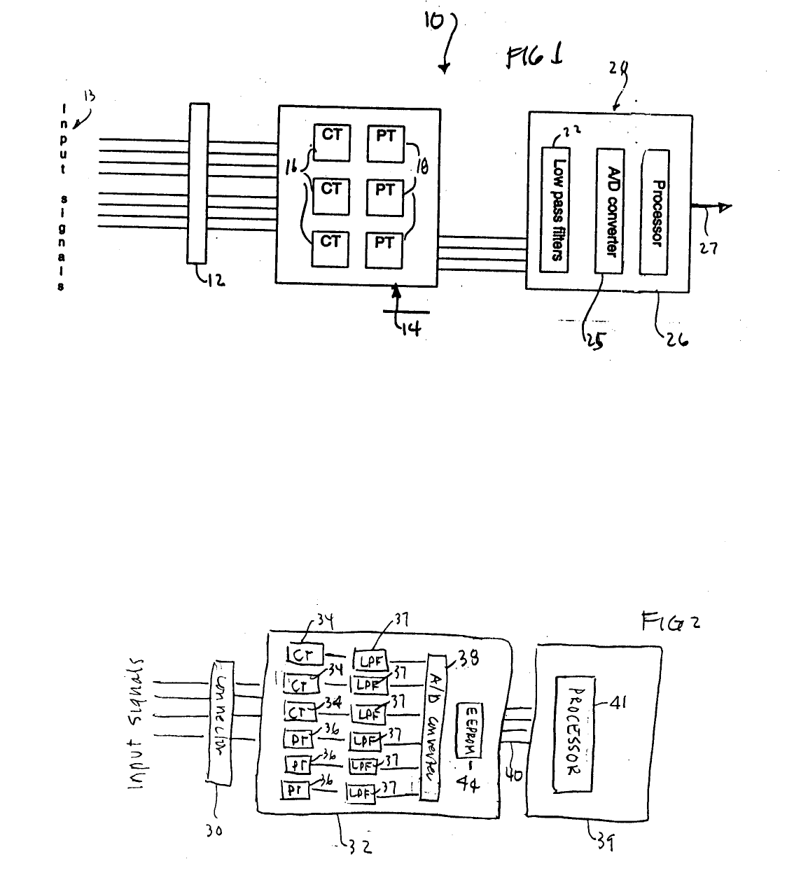

### BEST MODE FOR CARRYING OUT THE INVENTION

Referring now to FIG. 2, input signals (voltage and/or current) from the power line are applied through a connector 30 and then to an interface board 32. Located on the interface board 32 are current transformers 34-34 for each of the three phases (A, B and C) of the input power signal and potential transformers 36-36 which are responsive to the three voltage phase signals from the power line. Also on the interface board 32 in the embodiment shown are a plurality of low-pass filters 37-37, one for each channel, which are responsive to outputs from the CTs and PTs 34 and 36, respectively. As indicated above, it is the CTs, PTs and low-pass filters which account for substantially all the errors in the relay system that require calibration/correction for proper operation of the system. Alternatively, and in some cases preferred, the CTs with their low-pass filters could be on a different board from the PTs with their low-pass filters.

It is desirable to have the analog-to-digital converter 38 portion of the system on interface board 32 as well, since the A/D converter does introduce an error, albeit quite small. The output of the A/D converter 38 is digital signals, which are then applied via a cable or ribbon connector 40 or by any other means (if the A/D converter is on interface board 32) to main board 39, which contains the main relay processor 41. Basically, in such an arrangement, the outputs of the A/D converter are the inputs to the main board 39. The particular protection function carried out by processor 41 is not essential to the invention. Various protective functions can be accomplished by processor 41 using the structural arrangement of the present invention.

As indicated above, each of the individual elements shown, e.g. CTs, PTs and low-pass filters, will produce an error, magnitude and phase. In the present invention, errors from the CTs and PTs as well as the errors due to the low-pass filters are totaled as a calibration or correction factor for each channel and then stored on the interface board 32, typically in an EEPROM 44 or other similar storage device, such as flash memory. Hence, the correction factors for the various system components located prior to the main processor are stored on the particular input board containing those components, instead of on the main board. The signals from the interface board 32 or other input boards include calibration/correction factors which are then used in the processor on the main board to correct the component signals applied to it for processing.

For example, a particular PT (potential transformer) magnitude error may be +2% with an associated low-pass filter error of −1%, leading to a magnitude correction factor for that channel of −1%. Similar correction is made for phase errors. This correction factor in the present invention is stored on the input board containing those components, rather than on the main board, as is presently done. If for any reason the interface board or other input board containing components is to be changed, such as due to a failure in one or more of the board components, e.g. low-pass filters, PTs or CTs, or if the range of the input signals is to be changed, for whatever reason, the replacement board will be already calibrated for the components thereon, whether the customer already has such a board in its possession or whether it obtains a new board from the manufacturer. Each such board, with CTs and/or PTs and low-pass filters thereon, will carry its own calibration factor on it. For instance, if the new board contains components with a total error of 4%, then the board will have a correction factor of 4% stored thereon. As indicated above, the correction (magnitude and phase) will usually be on a channel-by-channel basis.

Therefore, since each board has the correction factor thereon for its components, a new board can be swapped directly for an old board, without a need to recalibrate the entire relay, since the correction factor is present on the board itself. This eliminates the problematic and time-consuming shipping of the entire relay back to the manufacturer and then returning the unit to the customer when the recalibration is completed. With the present invention, the customer retains the relay and simply swaps individual boards when board(s) with CTs, PTs and low-pass filters is to be replaced.

In an alternative arrangement, the analog-to-digital converter 48 could be on the main board 39 with the system processor instead of on the interface board or other input board. The preferred location, however, is on the same board with the CTs and PTs, since the A/D converter does introduce a small error. Further, as discussed above, interface board 32 could be in two separate parts (such as two boards), one for the CTs (three phases) and their associated low-pass filters, and one for the PTs (three phases) and their associated low-pass filters. However, it is important that the elements which have errors which must be corrected by a correction factor are on input signal boards which are separate from the main processing board and, further, that the correction factor for the components on a particular board be carried on that board.

As indicated above, when an interface board is to be replaced, for whatever reason, it will no longer be necessary to provide the entire relay back to the manufacturer for calibration, since the correction factor(s) for the elements on the board are stored on the board.

In operation, the output signals from the input signal board(s) will be applied to the main board for processing along with the correction factor(s) for the board. The system processor for the protective relay will then make the required calculation with the correction factor(s). The components requiring correction can either be all on one board or on more than one board, each with its required correction factor.

Accordingly, a preferred embodiment has been described for purposes of illustration. However, it should be understood that various changes, modifications and substitutions may be incorporated in the embodiment without departing from the spirit of the invention, which is defined by the claims which follow.

What is claimed is:

1. A structural system for a protective relay used in an electric power system, the relay being responsive to power signals from an electric power line, comprising:
a main circuit board containing a processor for processing digital input signals thereto to carry out protection functions for the relay;
at least one input signal board separate from the main board responsive to analog input signals from the power system, the input signal board having components thereon which require calibration to produce accurate output signals, wherein the input board also has stored thereon calibration information necessary for said accurate output signals, wherein noncalibrated output signals from the input signal board are, following analog-to-digital conversion, communicated to said processor, along with the calibration information stored on the input signal board, for processing, wherein a change of the input signal board does not require recalibration of the entire relay.

2. A system of claim 1, wherein the components on the input signal board requiring calibration include at least one of the following: at least one current transformer, low-pass filters associated therewith, at least one potential transformer and low-pass filters associated therewith.

3. A system of claim 1, wherein the components on the input signal board include current transformers for all three power signal phases, low-pass filters associated therewith, potential transformers for all three phases and low-pass filters associated therewith.

4. A system of claim 3, wherein all of said components are on one input signal board.

5. A system of claim 4, wherein the input signal board also includes an A/D converter responsive to the output of the low-pass filters.

6. A system of claim 1, wherein the calibration is carried out for both magnitude and phase errors.

7. A system of claim 3, wherein the current transformers and their associated low-pass filters are on a first input signal board and wherein the voltage transformers and their associated low-pass filters are on a second input board.

8. An input signal board for use in a protective relay used in an electric power system, the relay being responsive to power signals from an electric power line and including a main circuit board which includes a processor for processing digital input signals thereto to carry out protection functions for the relay, the input signal board comprising:
an input signal board having at least one of the following thereon: (a) current transformers for all three phases of the power signal from the power line and a low-pass filter for each current transformer and (b) potential transformers for all three phases of the power signal from the power line and a low-pass filter for each potential transformer, wherein the current transformers and the potential transformers require calibration to produce accurate output signals, wherein the input signal board has stored thereon calibration information necessary for said accurate output signals, wherein noncalibrated output signals from the input signal board are, following analog-to-digital conversion, communicated to said processor, along with the calibration information stored on the input signal board, for processing, wherein the input signal board can be changed in the relay without recalibration of the entire relay.

9. A input signal board of claim 8, wherein the current transformers and their low-pass filters and the potential transformers and their low-pass filters are all on said input signal board.
